(19) United States
(12) Patent Application Publication
(10) Pub. No.: US 2019/0195367 A1
(43) Pub. Date: Jun. 27, 2019

(54) MECHANICAL SEAL ARRANGEMENT WITH A COATED BELLOWS UNIT

(71) Applicant: EagleBurgmann Germany GmbH & Co. KG, Wolfratshausen (DE)

(72) Inventors: Andreas Pehl, Poing (DE); Jorg Thelke, Wolfratshausen (DE); Tino Moller, Barum (DE); Joachim Skrzidlo, Wolfratshausen (DE)

(21) Appl. No.: 16/311,501

(22) PCT Filed: Apr. 18, 2017
(86) PCT No.: PCT/EP2017/059183

§ 371 Date: Dec. 19, 2018

(30) Foreign Application Priority Data
Jun. 30, 2016 (DE) 10 2016 211 816.1

(51) Int. Cl. F16J 15/36

(52) U.S. Cl. CPC F16J 15/363

(57) ABSTRACT

The invention relates to an mechanical seal arrangement, comprising a rotating slide ring (2) and a stationary slide ring (3) which define a sealing gap (4) in between them; a bellows unit (5) with a bellows element (50), a bellows support (51), and a slide ring support (52); wherein the bellows element (50) is connected in a fluid-tight manner to the bellows support (51) and the slide ring support (52); wherein the bellows unit (5) has a side that faces towards the product (7) and an atmospheric side (8); wherein the side of the bellows unit (5) that faces towards the product (7) has a non-stick coating (6); wherein the bellows element (50) is a metal bellows; and wherein the slide ring that is inserted into the slide ring support (52) of the bellows unit (5) is inserted loosely.

The present invention relates to a mechanical seal arrangement with a coated bellows unit for ensuring a function of the bellows unit.

Mechanical seal arrangements are known from the state of the art in different designs. To ensure adjustment of a slide ring in the axial direction during operation of the mechanical seal arrangement, bellows elements are used that are connected to the slide ring to be adjusted in the axial direction. The bellows elements ensure axial movability of this slide ring.

However, mechanical seals also have to fulfill sealing functions with respect to media, such as e.g. hot water or liquid concrete, with which deposits at the bellows element occur. Over time, such deposits fill up the bellows folds of the bellows element, so that the axial movability of the bellows element is compromised. This in particular relates to bellows that are made of metal, as they have relatively stiff bellows folds.

What is known from DE 102014207188 B4 is a mechanical seal arrangement with an elastic bellows element that is made of an elastomeric material and has a non-stick coating. This bellows element has no bellows folds but a curved flexible bellows intermediate space in which the above-mentioned deposit problem does not occur.

Further, if the bellows units are used in mechanical seal arrangements with metal bellows, what arises is the problem that the metal bellows usually has to be welded to the slide ring support. Here, the slide ring may for example be attached in the slide ring support by means of a shrink connection. Here, the manufacture of the shrink connection is carried out prior to the bellows element being welded onto the slide ring support, since a slide ring support with welded-on bellows element would not fit into a shrink-fitting machine. Therefore, in mechanical seal arrangements with bellows units, the shrinking process often causes a warpage of the slide ring in the slide ring support, which may entail extensive post-processing.

Thus, it is the objective of the present invention to provide a mechanical seal arrangement with a bellows unit which provides a long service life also when sealing media that are prone to deposits, and provides a long service life and functional reliability, while at the same time having a simple structure and a simple, cost-effective manufacturability.

This objective is achieved through a mechanical seal arrangement with the features of claim 1. The subclaims indicate preferable further developments of the invention.

The mechanical seal arrangement according to the invention with the features of claim 1 has the advantage that deposits at a bellows element of a bellows unit can be prevented. In this manner, a service life and functional reliability of the bellows unit and in particular a movability of a bellows element can be maintained over a long time. The bellows unit comprises a bellows element, a bellows support, and a slide ring support. Here, the bellows element is connected in a fluid-tight manner to the bellows support and the slide ring support. At a product side that is in contact with the medium to be sealed, the bellows element has a non-stick coating. Here, the coating is preferably present at the complete product side of the bellows unit, i.e., the bellows element, the bellows support, and the slide ring support. Here, the bellows element is a metal bellows, in particular having a plurality of bellows folds. Further, a slide ring is loosely inserted into the slide ring support of the bellows unit. In this manner, tensions or warping or the like inside the slide ring can be avoided.

Thus, according to the invention, the complete bellows unit is provided with a non-stick coating at a product side, i.e., the flexible bellows element, the bellows support, and the slide ring support. For manufacturing, the metal bellows is attached at the bellows support and the slide ring support already earlier, e.g. it may be welded onto it. During this welding process, the slide ring does not have to be arranged in the slide ring support, as the slide ring is later loosely inserted into the slide ring support.

Preferably, the non-stick coating is a DLC coating. DLC coatings have very good non-stick properties and can be applied to the product side of the bellows unit in a simple and cost-effective manner as well as with a relatively small thickness.

The non-stick coating preferably has a thickness in a range of 1/200 to 1/10, in particular of 1/100 of a bellows element thickness. In this manner, it is ensured that a dimensioning of the bellows unit in the radial direction is changed only minimally by the coating. The thickness of the coating on the bellows unit is preferably in a range of 0.1 μm to 20 μm, and is in particular in a range of 0.7 μm to 3 μm.

It is particularly preferable if the mechanical seal arrangement further comprises a first sleeve that has a first ring flange at a first end, and preferably has a second ring flange at a second end. The first sleeve is provided for connecting the loosely placed slide ring to the slide ring support. Here, the slide ring support has a groove for receiving the first ring flange, wherein a snap-in connection is provided between the groove and the first ring flange. The snap-in connection is thus provided by an undercut, so that a quick and simple click mounting of the first sleeve at the slide ring support is facilitated. Further, the first sleeve preferably comprises a second ring flange, and the loosely placed slide ring has a ledge at a side that faces towards the other slide ring. In this manner, a movability of the loosely placed slide ring between the second ring flange and the slide ring support is limited in the axial direction of the mechanical seal arrangement.

Preferably, the bellows element has a plurality of bellows folds, wherein each bellows fold has a maximum depth that is equal to or smaller than a double maximum width of the bellows fold. By means of this definition of the depth to the width of the bellows fold it is ensured that all areas of the bellows fold can be coated.

Preferably, an additional seal, in particular an O-ring, is arranged between the loosely inserted slide ring and the slide ring support. The additional seal is in particular used for affixing the loosely inserted slide ring inside the slide ring support. Here, the affixing by means of the additional seal ensures that no undesired tensions or the like are introduced into the loosely inserted slide ring. The additional seal is preferably provided in a ring-shaped recess at the slide ring support.

To facilitate a sufficient movability of the coated bellows element in the axial direction, a ratio of a hardness of the coated bellows elements to a E-module of the coated bellows element is in a range of 1:6 to 1:8. Particularly preferably, the ratio of hardness to the E-module of the coated bellows element is 1:7.

It is further preferred if the non-stick coating is provided continuously at the bellows unit. Thus, the non-stick coating is completely provided at a product side, i.e., in all areas of the bellows unit that are in contact with the medium to be sealed.

It is further preferred if a first welded connection is formed between the metal bellows and the bellows support, and a second welded connection is formed between the metal bellows and the slide ring support. The two welded connections are preferably realized prior to coating the bellows unit to avoid any damage to the coating by subsequent welding procedures.

Further, the bellows unit preferably has a first non-stick coating at the side that faces towards the product, and has a second non-stick coating at the atmospheric side. Thus, the bellows unit and in particular the bellows element is coated on both sides. Thus, in the case that a leakage of the medium to be sealed occurs via the sealing gap between the slide rings towards the atmospheric side of the bellows unit, it can also be avoided that deposits or the like form at the atmospheric side of the bellows unit. Thus, a particularly long service life and good movability of the bellows unit can be ensured. Particularly preferably, a thickness of the second coating is equal to a thickness of the first coating. Further, it is also preferable if the coatings are identical. It is further preferred if the bellows unit, i.e. the bellows element, the bellows support, and the slide ring support, are completely coated on both sides.

It is particularly preferable if the mechanical seal arrangement according to the invention is used for sealing media with which deposits often occur. Such media may for example be liquid concrete or hot water, wherein in the case of hot water what often occurs are calcifications.

In the following, a preferable exemplary embodiment of the invention is described in detail by referring to the accompanying drawing. Herein:

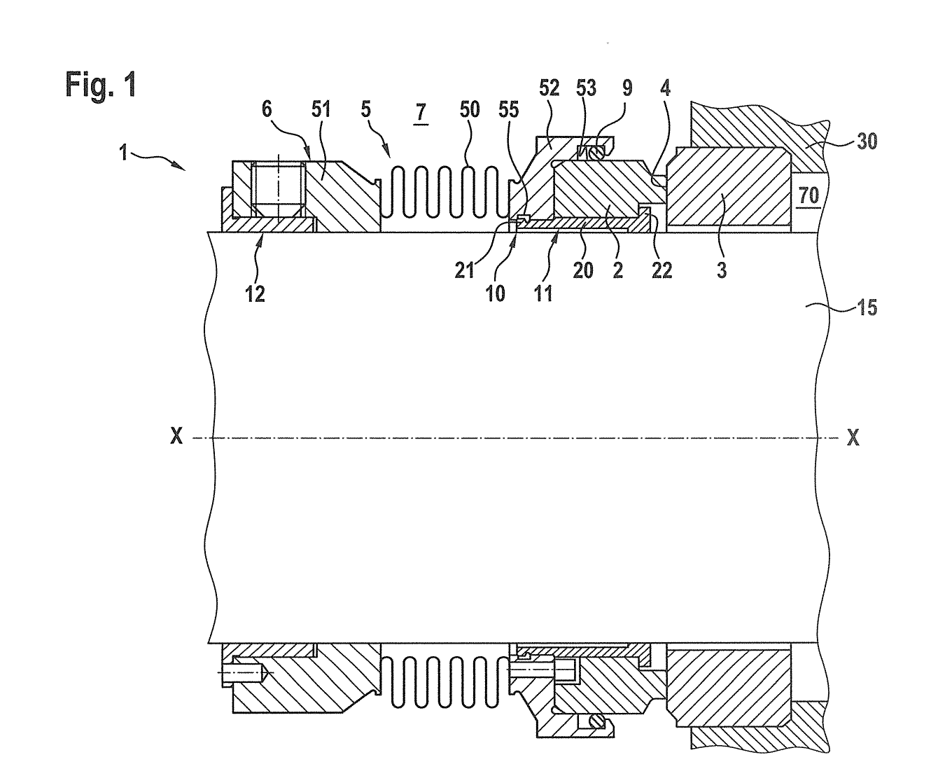

FIG. 1 shows a schematic sectional view of a mechanical seal arrangement according to a first exemplary embodiment of the invention;

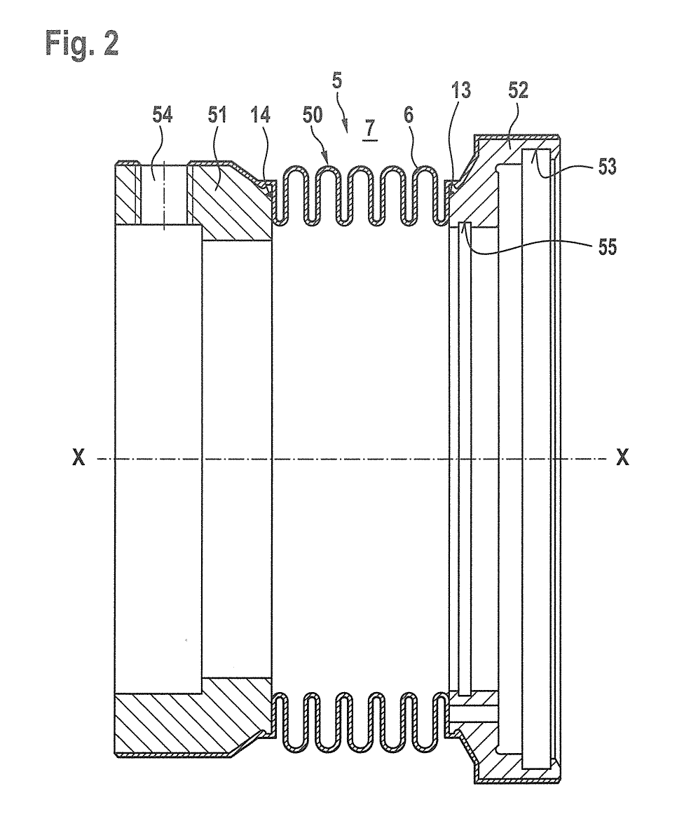

FIG. 2 shows a schematic sectional view of a bellows unit of FIG. 1;

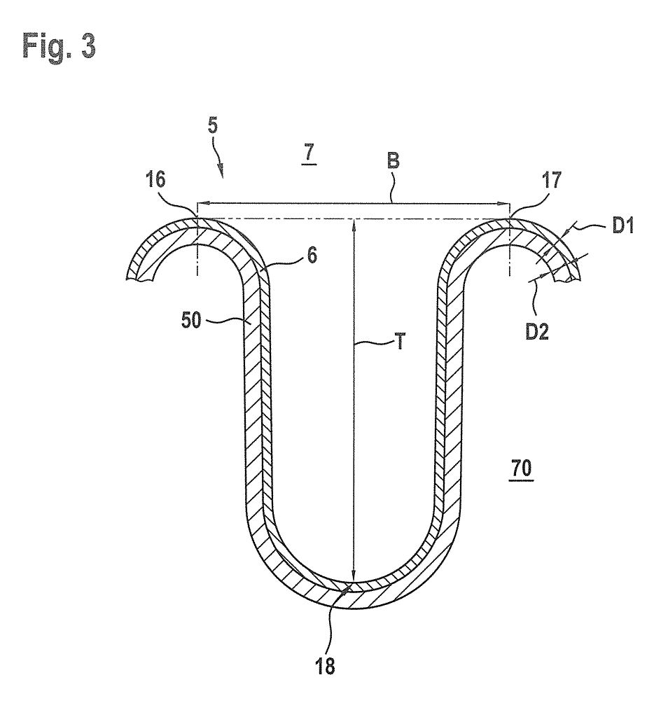

FIG. 3 shows a schematic sectional view of a loop of a bellows element of FIG. 2, and

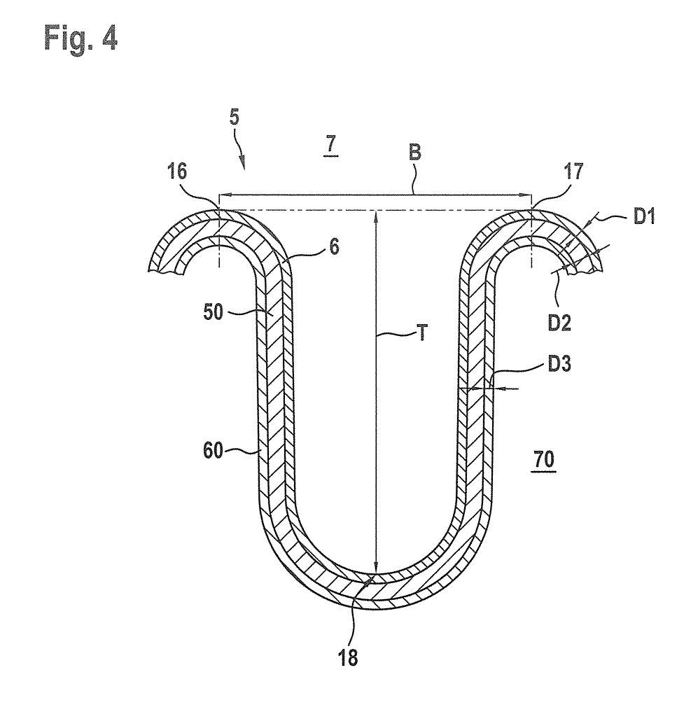

FIG. 4 shows a schematic sectional view of a loop of a bellows element of a bellows unit according to a second exemplary embodiment of the invention.

In the following, a mechanical seal arrangement 1 according to a first preferable exemplary embodiment of the invention is described in the detail.

As can be seen in FIG. 1, the mechanical seal arrangement 1 comprises a mechanical seal with a rotating slide ring 2 and a stationary slide ring 3 which define a sealing gap 4 in between them.

Further, the mechanical seal arrangement 1 comprises a bellows unit 5, which can be seen in detail in FIG. 2. The bellows unit 5 comprises an elastic bellows element 50, a bellows support 51, and a slide ring support 52. The elastic bellows element 50 is a bellow of a metal material, in particular of spring steel. In this exemplary embodiment, the bellows element is provided as a round bellows. It is to be understood that also a bellows with pointed folds can be provided as a flexible bellows element.

As can be seen in FIG. 2, a side of the bellows unit 5 that faces towards the product 7 has a non-stick coating 6. In this exemplary embodiment, the non-stick coating 6 is a DLC coating.

Here, the non-stick coating 6 is provided completely at the side of the bellows unit 5 that faces towards the product 7. Here, the coating 6 does not have any interruption, or the like.

As shown in FIG. 2, a threaded bore 54 not having a coating can further also be provided in the bellows support 51. The threaded bore 54 is covered during the coating procedure, for example with a plug. By means of the threaded bore 54, the bellows unit 5 can be affixed at a second sleeve 12 (cf. FIG. 1). The second sleeve 12 serves for affixing the bellows support 51 on the shaft 15.

As can be seen in FIG. 3, the non-stick coating 6 has a constant first thickness D1 that is approx. 1/100 of a constant second thickness D2 of the bellows element 50. In FIG. 3, the proportions of the thicknesses D1 and D2 are not rendered true to scale with a view to providing a clearer rendering. Here, the non-stick coating 6 is formed completely in a bellows fold of the bellows element 50. A width B of the bellows fold is defined by a distance between two radially outermost points 16,17 that delimit the bellows fold. A depth T of the bellows fold is defined by a distance of a radially innermost point 18 of the bellows fold to the line that connects the two radially outermost points. Here, a depth T corresponds to twice the width B of the bellows fold.

Here, the thickness D1 of the non-stick coating 6 is in a range of 0.1 μm to 20 μm, and in particular is between 0.7 μm and 3 μm.

Further, an additional seal 9 in the form of an O-ring is provided between the rotating slide ring 2 and the slide ring support 52. The additional seal 9 is arranged inside a first groove 53 in the slide ring support 52. The additional seal 9 prevents the product 7 from travelling from the product side to an atmospheric side 70 along the area of the rotating slide ring 2 that faces away from the stationary slide ring 3. The stationary slide ring 3 is affixed at a housing 30.

Thus, the additional seal 9 clamps the rotating slide ring 2 between the slide ring support 52 and the first sleeve 11.

The slide ring support 52 loosely receives the rotating slide ring 2, as can be seen in FIG. 1. Here, the rotating slide ring 2 is affixed at its inner circumference by a first sleeve 11. The first sleeve 11 comprises a cylindrical main body 20, a first ring flange 21 at a first end, and a second ring flange 22 at a second end.

A snap-in connection 10 is formed between the first ring flange 21 and a second groove 55 in the slide ring support 52. The snap-in connection 10 is established simply by axially sliding on the slide ring support 52 onto the first sleeve 11. In the loosely mounted state of the rotating slide ring 2, the second ring flange 22 prevents the rotating slide ring 2 from being moved in the axial direction X-X in the direction towards the stationary slide ring 3.

Further, the flexible bellows element 50 is connected to the slide ring support 52 by means of a first welded seam 13, and is connected to the bellows support 51 by means of a second welded seam 14.

Thus, for manufacturing the coated bellows unit 5, at first the bellows element 50 is welded onto the bellows support 51 and the slide ring support 52. Subsequently, the non-stick coating 6 is applied to the bellows unit 5, wherein the side of the bellows unit 5 that faces the product 7 is completely coated. In the course of this procedure, possibly present openings are covered with plugs or covers or the like to avoid that a coating is present at inner areas that later in the mounted state are oriented towards the atmospheric side 70. Subsequently, the rotating slide ring 2 is loosely inserted into the slide ring support 52, and the first sleeve 11 is slid on in the axial direction, until the snap-in connection 10 is established between the first ring flange 21 and the second groove 55 in the slide ring support 52. Subsequently, mounting onto the shaft 15 is performed.

Thus, deposits are prevented from forming at the side of the bellows unit 5 that faces towards the product 7 by means of a one-sided coating of the bellows unit 5 at the side that faces towards the product 7. The non-stick coating 6 prevents the adhering of any such particles. In this manner, the movability of the flexible bellows element 50 in the axial direction X-X of the mechanical seal arrangement 1 is not restricted. Also, no deposits occur in the area of the slide ring support 52 and of the bellows support 51 at the side that faces towards the product 7.

Since the bellows unit 50 has be assembled already prior to coating, the slide ring that is to be inserted into the slide ring support 52 can be loosely inserted in the subsequent mounting step. This has the advantage that it can be prevented that the slide ring is subjected to excessively high thermal loads, for example when the bellows element 50 is affixed at the slide ring support 52, and that any damage to the slide ring can thus occur.

Thus, based on the idea of a metallic bellows element 50 coated with a non-stick coating 6, a loosely inserted rotating slide ring 2 can be used, at which no damage occurs during mounting and no post-processing or the like is necessary. Positioning of the rotating slide ring 2 at the slide ring support 52 is realized by means of a releasable snap-in connection 10. This snap-in connection 10 can be manufactured in a simple manner and provides a reliable support of the rotating slide ring 2.

FIG. 4 shows a bellows loop of a bellows unit 5 according to a second exemplary embodiment of the invention. In contrast to the first exemplary embodiment, the elastic bellows element 50 is coated on both sides. Thus, the bellows unit 5 of the second exemplary embodiment comprises a first non-stick coating 6 at the side of the elastic bellows element 50 that faces towards the product 7, and a second non-stick coating 60 at the side of the elastic bellows element 50 that faces towards the atmospheric side 70. Here, the second non-stick coating 60 has a third thickness D3. The third thickness D3 is equal to the first thickness D1.

Preferably, the first and second non-stick coatings are respectively DLC coatings. Thanks to the coating on both sides of the elastic bellows element 50, it is ensured that, in the event that a medium to be sealed leaks through the sealing gap between the slide rings towards the atmospheric side 70, depositing at the elastic bellows element 50 at the atmospheric side 70 is prevented. Thus, a particularly long service life and movability of the bellows unit 5 can be ensured. Preferably, the complete bellows unit, i.e. the elastic bellows element 50, the bellows support 51, and the slide ring support 52, is completely provided with the non-stick coating.

### PARTS LIST

1 mechanical seal arrangement
2 rotating slide ring
3 stationary slide ring
4 sealing gap
5 bellows unit
6 first non-stick coating/first DLC coating
7 product
9 O-ring/additional seal
10 releasable snap-in connection
11 first sleeve
12 second sleeve
13 first welded seam
14 second welded seam
15 shaft
16, 17 radially outermost points of the bellows element
18 radially innermost point of a bellows fold
20 cylindrical main body
21 first ring flange
22 second ring flange
30 housing
50 elastic bellows element
51 bellows support
52 slide ring support
53 first groove
54 threaded bore
55 second groove
60 second non-stick coating/second DLC coating
70 atmospheric side
D1 first thickness
D2 second thickness
D3 third thickness
B width
T depth
X-X axial direction

1. Mechanical seal arrangement, comprising:
a rotating slide ring and a stationary slide ring which define a sealing gap in between them;
a bellows unit with a bellows element, a bellows support, and a slide ring support;
wherein the bellows element is connected in a fluid-tight manner to the bellows support and the slide ring support;
wherein the bellows unit has a side that faces towards the product and an atmospheric side;
wherein the side of the bellows element that faces towards the product has a non-stick coating;
wherein the bellows element is a metal bellows; and
wherein the slide ring that is inserted into the slide ring support of the bellows unit is inserted loosely.

2. Arrangement according to claim 1, wherein the non-stick coating is a DLC coating.

3. Arrangement according to claim 1, wherein the non-stick coating has a first thickness (D1) that is in the range of 1/200 to 1/10, in particular of 1/100 of a second thickness (D2) of the bellows element.

4. Arrangement according to claim 3, wherein the first thickness (D1) of the non-stick coating is between 0.1 μm to 20 μm.

5. Arrangement according to claim 1, further comprising a first sleeve with a first ring flange that is oriented radially outwards at a first end of the first sleeve, wherein the first sleeve supports the loosely inserted slide ring at the slide ring support, and a groove for receiving the first ring flange is provided at the slide ring support, wherein a snap-in connection is provided between the groove and the first ring flange.

6. Arrangement according to claim 5, wherein the first sleeve has a second ring flange at a second end of the first sleeve, wherein the loosely inserted slide ring is supported between the second ring flange and the slide ring support.

7. Arrangement according to claim 1, wherein the bellows element has a plurality of bellows folds, wherein each bellows fold has a maximum depth (T) which is equal to or smaller than twice the maximum width (B) of the bellows fold.

8. Arrangement according to claim 1, wherein an additional seal, in particular an O-ring, is arranged between the loosely inserted slide ring and the slide ring support.

9. Arrangement according to claim 8, wherein the slide ring support has a groove inside of which an additional seal is arranged.

10. Arrangement according to claim 1, wherein the coated bellows element has a ratio of a hardness to an E-module of the coated bellows element that is in a range of 1:6 to 1:8.

11. Arrangement according to claim 1, wherein the non-stick coating is formed continuously at the side of the bellows unit that faces towards the product.

12. Arrangement according to claim 1, wherein a first welded connection is provided between the bellows element and the slide ring support, and a second welded connection is provided between the bellows element and the bellows support.

13. Arrangement according to claim 1, wherein the bellows element has a second non-stick coating at a side that faces towards an atmospheric side.
